(19) United States
(12) Patent Application Publication
(10) Pub. No.: US 2021/0198035 A1
(43) Pub. Date: Jul. 1, 2021

(54) DEBRIS COLLECTION DEVICE

(71) Applicant: Marc Good, St. Petersburg, FL (US)

(72) Inventor: Marc Good, St. Petersburg, FL (US)

(21) Appl. No.: 16/730,319

(22) Filed: Dec. 30, 2019

(51) Int. Cl. B65F 1/14; B65F 1/10

(52) U.S. Cl. CPC B65F 1/1415; B65F 2240/138; B65F 1/10

(57) ABSTRACT

A debris collection device includes a mouth having an upper wall, sidewalls, and a lower wall defining a mouth opening therebetween. A bag coupler is attached to the mouth and is configured to releasably couple a bag to the mouth. A chute includes an elongated base extending from the lower wall of the mouth and leads into the mouth opening. Sidewalls upstand from opposing sides of the elongated base. The chute further includes an open front portion and an open top portion. The chute delivers the debris into the bag while the mouth keeps the bag open.

### BACKGROUND OF THE INVENTION

The present invention relates to raking leaves and, more particularly, to a debris collection device for collecting raked leaves.

Many municipalities have laws prohibiting the dumping or burning of leaves and other debris. The debris must therefore be collected in trash bags, sometimes a specific type, size or color of trash bag, and set on the curb for pickup by a trash service or hauled to a specified disposal location. Unfortunately, raking up and bagging fall leaves is difficult for a single person to undertake. Once the leaves are raked into piles, it is difficult to hold the garbage or leaf bag open and at the same time insert handfuls of slippery leaves. Some people put one foot on the edge of the trash bag, lean over and hold the bag open with one hand, and attempt to scoop in leaves with the other hand. Since only a comparative few leaves can be inserted with each handful or rake full, the job is labor intensive and sometimes results in back sprains, spasms, and aching muscles.

As can be seen, there is a need for a debris collection device for collecting raked leaves.

### SUMMARY OF THE INVENTION

In one aspect of the present invention, a debris collection device comprises: a mouth comprising an upper wall, sidewalls, and a lower wall defining a mouth opening therebetween; a bag coupler attached to the mouth and configured to releasably couple a bag to the mouth; a chute comprising an elongated base extending from the lower wall of the mouth and leading to the mouth opening, sidewalls upstanding from opposing sides of the elongated base, an open front portion, and an open top portion, wherein at least one mounting hole is defined through the elongated base, wherein the debris collection device comprises a ground configuration and an upright configuration, wherein the ground configuration comprises the bag coupled to the mouth by the bag coupler and the bag extending away from the chute, and the upright configuration comprising the bag coupled to the mouth by the bag coupler and the bag extending within the chute.

In another aspect of the present invention, a debris collection device comprises: a mouth comprising an upper wall, sidewalls, and a lower wall defining a mouth opening therebetween; a bag coupler comprising a plurality of knobs extending from an outer surface of the mouth, and a plurality of elastic bands positioned to wrap around the plurality of knobs; and a chute comprising an elongated base extending from the lower wall of the mouth and leading to the mouth opening, sidewalls upstanding from opposing sides of the elongated base, an open front portion, and an open top portion.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a side view of an embodiment of the present invention, illustrating a bag being positioned to couple to the present invention;

FIG. 3 is a side view of an embodiment of the present invention, illustrating a bag coupled to the present invention;

FIG. 4 is a cross-sectional view of the present invention taken along line 4-4 in FIG. 3;

FIG. 5 is a detail cross-section view of the present invention taken along line 5-5 in FIG. 4;

FIG. 6 is a front perspective view of an embodiment of the present invention in an upright storage configuration; and

FIG. 7 is a side view of an embodiment of the present invention in an upright storage configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a device that provides for a more efficient and inexpensive way to remove leaves and yard waste. The device includes a chute with a ring that holds the trash bag open, creating a more ergonomic solution to bagging leaves. The present invention keeps the bag open hands free, resulting in less bending over, and saving time and money.

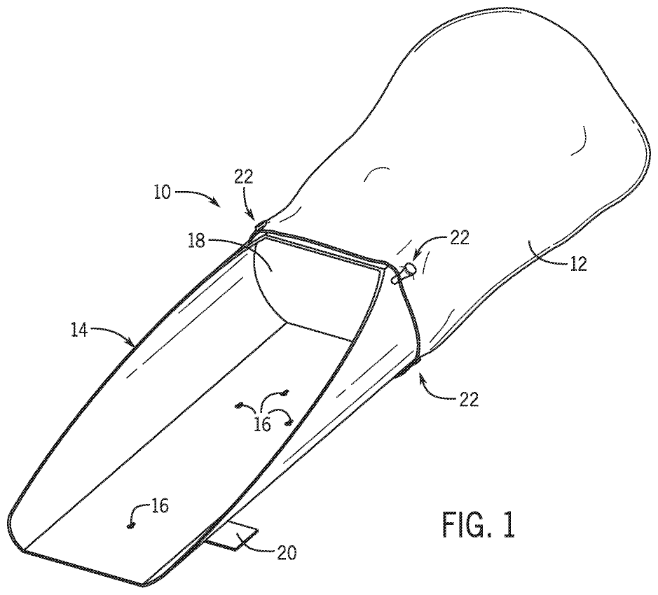

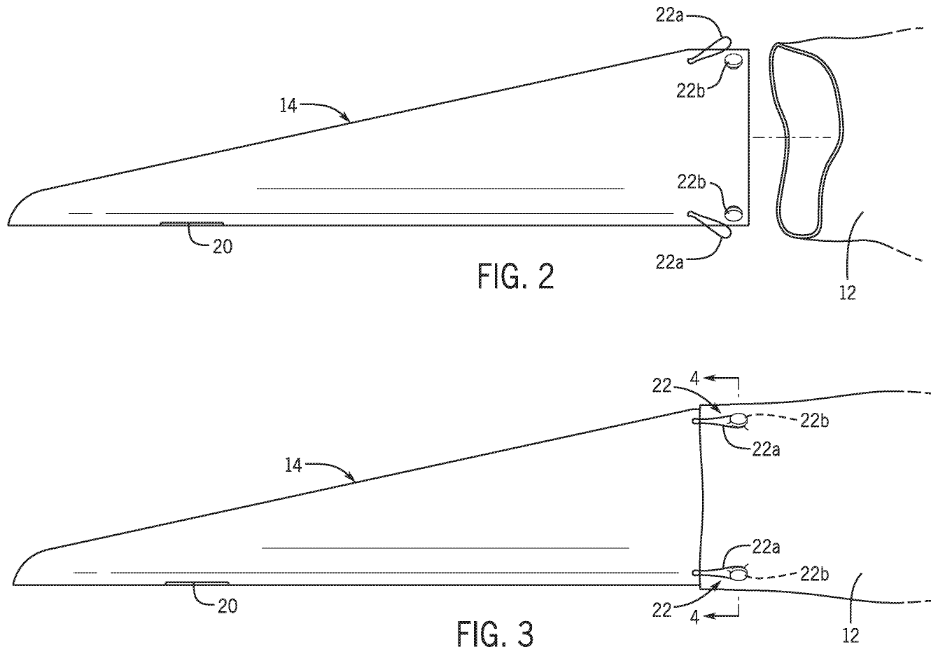

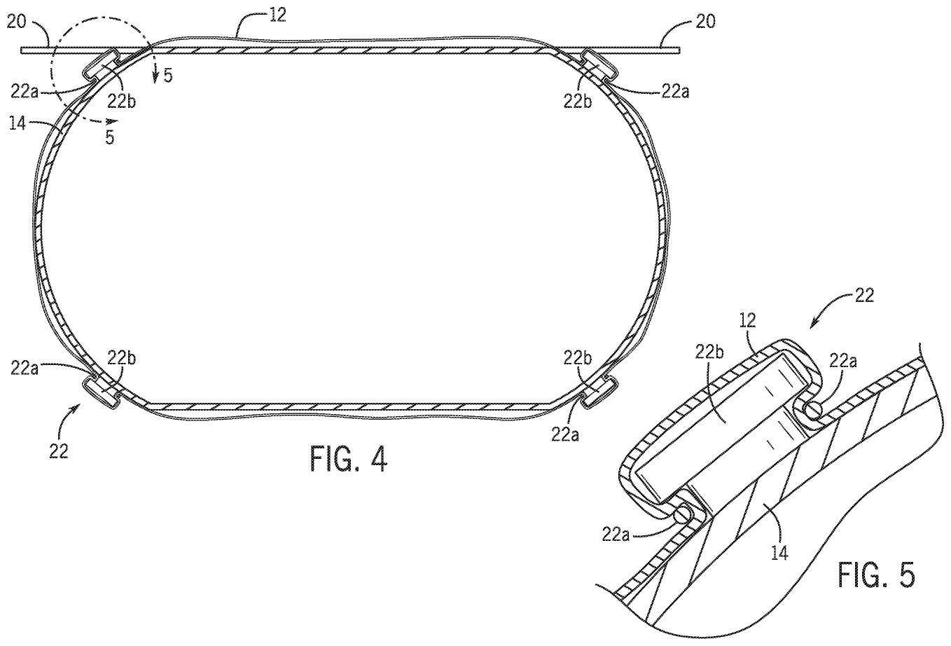

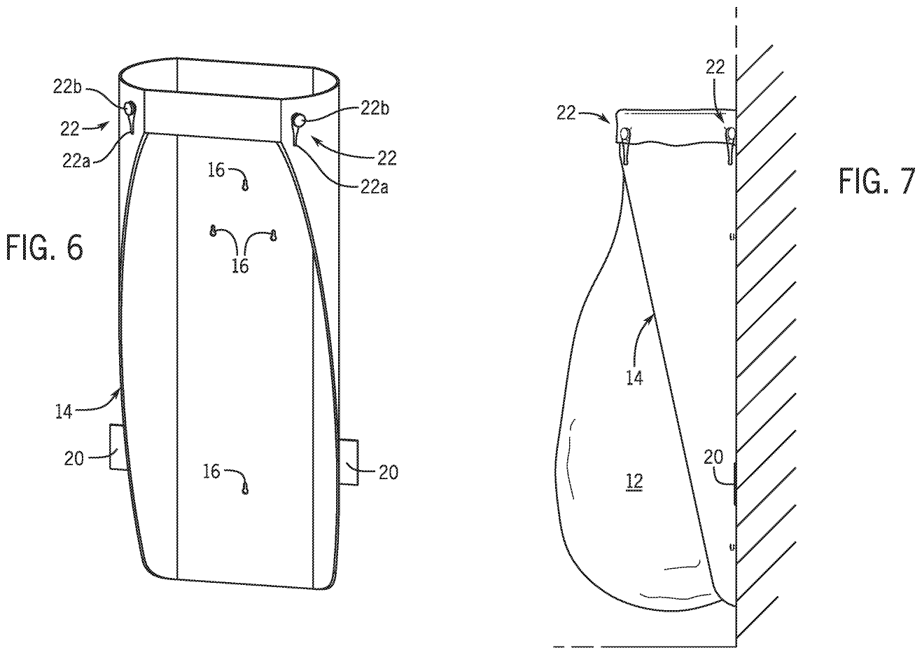

Referring to FIGS. 1 through 7, the present invention includes a debris collection device 10. The debris collection device 10 includes a mouth 18 having an upper wall, sidewalls, and a lower wall defining a mouth opening therebetween. A bag coupler 22 is attached to the mouth 18 and is configured to releasably couple a bag 12 to the mouth 18. A chute 14 includes an elongated base extending from the lower wall of the mouth 18 that leads into the mouth opening. Sidewalls upstand from opposing sides of the elongated base. The sidewalls of the chute 14 may taper from the mouth to the open front portion. The chute 14 further includes an open front portion and an open top portion. The chute 14 delivers the debris into the bag 12 while the mouth 18 keeps the bag 12 open.

The present invention may further include a stabilizer plate 20. The stabilizer plate 20 is attached to the elongated base of the chute 14 and extends laterally away from the elongated base. While in use, a user may step on the stabilizer plate 20 to keep the debris collection device 10 in place while the user rakes leaves through the chute 14 and into the bag 12.

In certain embodiments, the present invention includes at least one mounting hole 16 defined through the elongated base. For example, the present invention may include a plurality of mounting holes 16. The mounting holes 16 may be in the shape of key holes. The mounting holes 16 may secure the debris collection device 10 to a wall in an upright position.

The bag coupler 22 of the present invention may include a plurality of knobs 22b extending from an outer surface of the mouth 18. A plurality of elastic bands 22a may be secured to the mouth 18 adjacent to the knobs 22b and positioned to wrap around the plurality of knobs 22b. In certain embodiments, the plurality of the knobs 22b include a top wide portion and a bottom narrow portion. An annular channel is defined beneath the top wide portion and around the bottom narrow portion. The annular channel is sized to receive the elastic bands 22a. The knobs 22b and elastic cords 22a act as quick release snaps to secure the bag 12 to the mouth 18.

The debris collection device 10 includes a ground configuration and an upright configuration. The ground configuration is for raking leaves and includes the elongated base laying on the ground. The ground configuration further includes the bag 12 coupled to the mouth 18 by the bag coupler 22 and the bag 12 extending away from the chute 14. Leaves are raked through the chute 14 and into the bag 12. The upright configuration includes the debris collection device 10 upright and hanging by the mounting holes 16. The upright configuration further includes the bag 12 coupled to the mouth 18 by the bag coupler 22 and the bag 12 hanging within the chute 14. In such embodiments, the present invention may be used as a trash can.

It should be understood, of course, that the foregoing relates to exemplary embodiments of the invention and that modifications may be made without departing from the spirit and scope of the invention as set forth in the following claims.

What is claimed is:

1. A debris collection device comprising:
a mouth comprising an upper wall, sidewalls, and a lower wall defining a mouth opening therebetween;
a bag coupler attached to the mouth and configured to releasably couple a bag to the mouth;
a chute comprising an elongated base extending from the lower wall of the mouth and leading to the mouth opening, sidewalls upstanding from opposing sides of the elongated base, an open front portion, and an open top portion, wherein at least one mounting hole is defined through the elongated base, wherein
the debris collection device comprises a ground configuration and an upright configuration, wherein the ground configuration comprises the bag coupled to the mouth by the bag coupler and the bag extending away from the chute, and the upright configuration comprising the bag coupled to the mouth by the bag coupler and the bag extending within the chute.

2. The debris collection device of claim 1, further comprising a stabilizer plate laterally extending from the elongated base and away from the chute.

3. The debris collection device 1, wherein the at least one mounting hole comprises a plurality of key holes.

4. The debris collection device 1, wherein the bag coupler comprises a plurality of knobs extending from an outer surface of the mouth, and a plurality of elastic bands positioned to wrap around the plurality of knobs.

5. The debris collection device 1, wherein each of the plurality of the knobs comprise a top wide portion and a bottom narrow portion, wherein an annular channel is defined beneath the top wide portion and around the bottom narrow portion, the annular channel sized to receive the elastic bands.

6. The debris collection device 1, wherein sidewalls of the chute taper from the mouth to the open front portion.

7. A debris collection device comprising:
a mouth comprising an upper wall, sidewalls, and a lower wall defining a mouth opening therebetween;
a bag coupler comprising a plurality of knobs extending from an outer surface of the mouth, and a plurality of elastic bands positioned to wrap around the plurality of knobs; and
a chute comprising an elongated base extending from the lower wall of the mouth and leading to the mouth opening, sidewalls upstanding from opposing sides of the elongated base, an open front portion, and an open top portion.

8. The debris collection device 7, wherein the elongated base comprises a plurality of keyholes defined therethrough.

9. The debris collection device 8, comprising a ground configuration and an upright configuration, wherein the ground configuration comprises the bag coupled to the mouth by the bag coupler and the bag extending away from the chute, and the upright configuration comprising the bag coupled to the mouth by the bag coupler and the bag extending within the chute.

10. The debris collection device of claim 7, further comprising a stabilizer plate laterally extending from the elongated base and away from the chute.
